(19) United States
(12) Patent Application Publication
(10) Pub. No.: US 2021/0404386 A1
(43) Pub. Date: Dec. 30, 2021

(54) GAS TURBINE ENGINE AND AIRCRAFT WITH A GAS TURBINE ENGINE

(71) Applicant: Rolls-Royce Deutschland Ltd & Co KG, Blankenfelde-Mahlow (DE)

(72) Inventors: Gideon Daniel VENTER, Berlin (DE); Michael SCHACHT, Berlin (DE); Sebastian KOPP, Berlin (DE); Rüdiger MERZ, Berlin (DE)

(21) Appl. No.: 17/362,347

(22) Filed: Jun. 29, 2021

(30) Foreign Application Priority Data
Jun. 30, 2020 (DE) 102020117255.9

(51) Int. Cl. F02C 7/32; F02C 7/36; F01D 15/10; B64D 41/00

(52) U.S. Cl. CPC F02C 7/32; F02C 7/36; F01D 15/10; B64D 27/20; F05D 2260/4031; F05D 2220/323; B64D 2041/002; B64D 41/00

(57) ABSTRACT

A gas turbine engine for an aircraft comprising an engine core and including a bypass channel which radially surrounds the engine core at least in part is described. A core shaft is operatively connected to an engine accessory gearbox, which is arranged between the engine core and the bypass channel, by means of a radial shaft of a drive train. An electric machine is provided which is designed to start the gas turbine engine during motor operation and to generate electrical energy during alternator operation. The electric machine is arranged coaxially with the core shaft and connected thereto for conjoint rotation. Alternatively, the electric machine can be arranged radially outside the bypass channel and can be operatively connected to the core shaft by means of the radial shaft, wherein a rotor of the electric machine is arranged coaxially with the radial shaft and connected thereto for conjoint rotation.

This application claims priority to German Patent Application DE102020117255.9 filed Jun. 30, 2020, the entirety of which is incorporated by reference herein.

The present disclosure relates to a gas turbine engine comprising an engine core and comprising a bypass channel and to an aircraft having at least one gas turbine engine of this type.

US 2009/0123274 A1 discloses a gas turbine engine comprising what is known as an engine accessory gearbox. The engine accessory gearbox is provided between an engine core and a bypass channel. The gas turbine engine additionally comprises what is known as a aircraft gas turbine accessory gearbox which is installed radially outside the bypass channel. The engine accessory gearbox is operatively connected to a high-speed spindle by means of a radial shaft and is driven by this spindle. In this case, the high-speed spindle has a high-speed compressor, a high-speed turbine and a high-speed shaft which connects the high-speed compressor to the high-speed turbine.

The aircraft accessory gearbox is connected to a low-speed spindle by means of another radial shaft and is driven by this spindle. The low-speed spindle has a low-speed compressor, a low-speed turbine and a low-speed shaft which connects the low-speed compressor to the low-speed turbine.

The engine accessory gearbox drives a lubrication pump and other accessories. A fuel pump, an alternator and a hydraulic pump are drivingly coupled to the aircraft accessory gearbox.

It is proposed to select the accessories which are driven by the engine accessory gearbox or by the aircraft accessory gearbox according to available installation space and the desired drive speed for the accessory in each case.

As a result of the two radial shafts, the gas turbine engine is characterized by an undesirably complex construction and, due to the large number of parts, has a high component weight and large external dimensions. All of this together causes high drag of the gas turbine engine, which increases fuel consumption of the gas turbine engine.

EP 0 659 234 B1 describes a gas turbine engine in which a radial shaft is connected to a low-pressure spindle by means of a reduction gearbox. The radial shaft extends from the low-pressure shaft as far as an inner gearbox which is arranged radially inside a bypass channel. The inner gearbox drives a hydraulic machine which can be operated as either a hydraulic motor or a hydraulic pump. Another radial shaft which is connected to an outer gearbox which is provided radially outside the bypass channel extends from the inner gearbox through the bypass channel.

The drive train between the low-pressure spindle and the outer gearbox has the disadvantage that the torque which is supplied to the outer gearbox is transmitted via the inner gearbox. For this reason, the inner gearbox is designed to be correspondingly powerful and thus leads to high production costs.

In addition, US 2014/0090386 A1 discloses a gas turbine engine comprising an engine accessory gearbox and comprising an aircraft accessory gearbox. The two accessory gearboxes are driven either by core shafts of the gas turbine engine by means of separate shafts or are each driven by one of the core shafts by means of a common drive train. In the case of the latter connection to a single core shaft by means of a common drive train, in each case, the torque supplied to the engine accessory gearbox or the aircraft accessory gearbox is conducted through the aircraft accessory gearbox or through the engine accessory gearbox, but this is undesirable. The accessory gearbox which transfers the torque towards the other accessory gearbox in each case is to be designed to be correspondingly robust, and this requires costly design measures.

The object of the present disclosure is that of providing a gas turbine engine which has a simple design and is characterized by small external dimensions, a low component weight and low production costs as well as being fuel efficient, and providing an aircraft characterized by low fuel consumption.

This object is achieved by a gas turbine engine and by an aircraft having the features of claims 1 and 10 respectively.

According to a first aspect, a gas turbine engine comprising an engine core and comprising a bypass channel is provided. The bypass channel radially surrounds the engine core at least in part. At least one core shaft extending in the axial direction of the gas turbine engine is provided. The core shaft is operatively connected to an engine accessory gearbox by means of a radial shaft of a drive train.

An electric machine is provided which is designed to start the gas turbine engine during motor operation and to generate electrical energy during alternator operation. The electric machine provides both the function of an alternator and the function of a pneumatic engine starter which is provided only to start a gas turbine engine, as a result of which less installation space is required and a low component weight is achieved by comparison with known gas turbine engines.

In addition, the electric machine can be arranged coaxially with the core shaft and connected thereto for conjoint rotation. The electric machine can then be driven by the core shaft in a constructionally simple manner which is advantageous in terms of installation space. Furthermore, the torque which is to be applied by the electric ma-chine to the core shaft in order to start the gas turbine engine can also be transmitted in a constructionally simple manner and with low installation space requirements. Moreover, it is advantageous that the electric machine which is arranged radially inside the engine core is to be connected to an external power source only by means of electrical lines in order to start the gas turbine engine.

The electric machine can radially surround the core shaft at least in part, can be radially arranged inside the core shaft at least in part and can also be positioned according to the present application in each case in the axial direction of the core shaft next to the core shaft at least in part.

The electrical lines can be guided radially outwards through the inside of struts, or through the inside of aerodynamic profiles which radially pass through the engine core and also through the bypass channel. Since electrical lines of this type have substantially smaller line cross sections for example in comparison with compressed air lines which are provided for the operation of a pneumatic engine starter, the cross sections of the struts or of the profiles can also designed to be smaller. The smaller cross sections of the struts or of the profiles thus also influence the flow cross section of the core flow channel in the engine core and also the flow cross section of the bypass channel to a lesser extent. As a result, the gas turbine engine can be designed with small dimensions overall, and this has a positive effect on the level of flow drag and the component weight.

Furthermore, the airflow through the bypass channel is also impaired to a limited extent, since the strut cross sections and the cross sections of the profiles can be provided to be correspondingly small. This also leads to a low level of flow drag of a gas turbine engine, which has a positive effect on fuel consumption.

Alternatively, it is possible for the electric machine to be arranged radially outside the bypass channel, that is to say on the side of the bypass channel facing away from the engine core when viewed in the radial direction, and to be operatively connected to the core shaft by means of the radial shaft. A rotor of the electric machine can be arranged coaxially with the radial shaft and connected thereto for conjoint rotation.

In the latter arrangement of the electric machine, the radial shaft, which is operatively connected to the core shaft, is to be guided radially outwards for example inside a strut or an aerodynamic profile through the bypass channel as far as the electric machine. As a result of the cross section of the strut or of the profile which is then to be provided to be bigger, the flow cross section of the bypass channel is impaired to a greater extent than is the case when the electric machine is arranged directly on the core shaft.

However, the region radially inside the engine core, which is to be dimensioned to be correspondingly large when the electric machine is arranged radially inside the engine core, can be designed to have smaller dimensions when the electric machine is arranged radially outside the bypass channel or on the side of the bypass channel facing away from the engine core.

In addition, it is also possible to arrange the electric machine radially outside the bypass channel in regions outside an engine nacelle, such as in the region of an engine pylon or even in the region of a fuselage of an aircraft so as to be able to design the gas turbine engine with small external dimensions and a low component weight.

Furthermore, electrically operable devices of the gas turbine engine which are provided radially inside the bypass channel can in turn receive electrical energy from the electric machine, which is arranged radially outside the bypass channel, via electrical lines in a manner which is advantageous in terms of installation space.

Additionally or alternatively, it can also be provided that the engine accessories or an engine control unit of the gas turbine engine are supplied with electricity by means of what is known as a permanent magnet alternator (PMA). A PMA of this type can be powered for example by the core accessory gearbox or the core shaft of the gas turbine engine.

The engine accessory gearbox can be arranged in an intermediate casing between the engine core and the bypass channel in a constructionally simple manner.

For the drive, the drive train can comprise an angle drive between the radial shaft and the core shaft, which angle drive can be for example in the form of a bevel gear set. Furthermore, the drive train can be designed with an additional angle drive between the radial shaft and the engine accessory gearbox.

The connection of the engine accessory gearbox to the drive train or to the radial shaft provides an interface or a support point for the radial shaft which allows an expansion of the radial drive starting from the core shaft towards the electric machine in a constructionally simple manner. The angle drive for removing torque from the radial shaft towards the engine accessory gearbox can be dimensioned in such a way that bevel gears and bearings which are advantageous in terms of installation space can be used. As a result, the integration of the engine accessory gearbox in the engine core, in which only limited installation space is available, is supported in a simple manner.

In the region of the engine accessory gearbox, it is thus possible, in a constructionally simple manner, to support the radial shaft which extends as far as the electric machine arranged radially outside the bypass channel and to limit bending movements of the radial shaft between bearing points. In turn, this makes it possible to design the diameter of the radial shaft substantially only according to the torque to be transmitted.

According to the present application in each case, it is possible for the angle drives to each be in the form of bevel gear sets in order to be able to introduce the torque from the radial shaft into the engine accessory gearbox at the desired angle in each case. In this case, it can be provided that the bevel gear sets comprise bevel gears which are connected to the radial shaft in a rotationally fixed manner. These bevel gears can be in engagement with additional bevel gears which are connected to the input shaft of the engine accessory gearbox or to the core shaft. Alternatively, it can also be provided that an input shaft of the engine accessory gearbox and also the core shaft are formed integrally with a corresponding bevel gear set, which are each in engagement with a bevel gear of the radial shaft.

If the radial shaft is formed as a single piece, the gas turbine engine according to the present disclosure can be installed in a simple manner.

Deviating from this, it can also be provided that the radial shaft has at least two radial shaft portions. The two radial shaft portions can be arranged coaxially with one another and one behind the other at least in some regions in the axial direction, and operatively connected to one another for conjoint rotation by means of a device such as a splined shaft connection or the like. Such a design of the radial shaft with multiple parts is simpler to produce in terms of manufacturing and is characterized by higher rigidity by comparison with a radial shaft formed as a single piece.

The rotor of the electric machine can be rotatably mounted in a stator of the electric machine in a constructionally simple manner which is advantageous in terms of installation space.

In an embodiment of the gas turbine engine according to the present disclosure which is advantageous in terms of installation space, what are known as engine accessories are substantially operatively connected to the drive train by means of the engine accessory gearbox. The engine accessories are provided to carry out functions of the gas turbine engine and are arranged between the engine core and the bypass channel.

As a result, it is ensured in a simple manner that operative connections between the engine accessories and regions of the gas turbine engine can be arranged on the engine core and can be designed with small dimensions. In this case, the operative connections can be lines through which fluids or electrical energy can be conducted, or also mechanical couplings such as shafts and the like.

If engine accessories are arranged outside a bypass channel, the operative connections extend through struts which radially pass through the bypass channel. However, the struts reduce the flow cross section of the bypass channel and affect an airflow which is conducted through the bypass channel. In this case, the cross sections of the struts are to be made greater, the more operative connections are to be guided through the bypass channel.

Furthermore, the reduction of the flow cross section of the bypass channel as a result of the cross sections of the struts requires the dimensions of the gas turbine engine to be increased. This is because the outside diameter of the bypass channel is to be designed to be correspondingly larger in order to be able to produce a required flow cross section of the bypass channel. However, an increase in the dimensions is undesirable, since drag of a gas turbine engine increases as the radial dimensions of an engine nacelle increase. The resulting fuel consumption impairs the range of an aircraft configured with a gas turbine engine and the payload thereof. A greater diameter of an engine nacelle also increases the total weight of a gas turbine engine, since a greater nacelle diameter requires a simultaneous increase in the nacelle length due to aerodynamics.

Moreover, the electric machine can be configured to substantially supply electrical energy to what are known as aircraft accessories which are electrically operable and are provided to carry out functions of an aircraft which is configured with the gas turbine engine according to the present disclosure.

The aircraft accessories can be arranged radially outside the bypass channel irrespective of the arrangement of the electric machine. Even when the electric machine is arranged directly on the core shaft, between the electric machine and the electrically operable aircraft accessories, only electrical lines which have insignificant diameters in comparison with the radial shaft and therefore do not impair the flow cross section of the bypass channel are to be guided through the bypass channel.

As a result, in a simple manner, it is possible to design an inside diameter of the bypass channel to be smaller by comparison with solutions in which aircraft accessories are also or exclusively arranged radially inside the bypass channel, that is to say radially inside a side of the bypass channel facing the engine core. The required flow cross section of the bypass channel can then also be provided with a correspondingly small outside diameter of the gas turbine engine. Furthermore, the airflow through the bypass channel is also impaired to a limited extent, since the strut cross sections and the cross sections of aerodynamic profiles can be provided to be correspondingly small. This leads to a low level of flow drag of a gas turbine engine, which has a positive effect on fuel consumption. In addition, a carrier structure of the gas turbine engine on the engine core can be designed with less strength when the aircraft accessories, which are often characterized by large dimensions and by a high component weight, are arranged radially outside the bypass channel.

Moreover, the aircraft accessories can be arranged radially outside the bypass channel in regions of the gas turbine engine in which an operating temperature of the gas turbine engine is lower than in regions which are located radially inside the bypass channel and thus closer to the engine core.

The engine accessory gearbox can be arranged at such a distance in relation to a central axis or axis of rotation of the gas turbine engine that oil return lines and sealing air lines can be designed without U-shaped curved portions. This is advantageous since, in such regions, preferably water and other material collects or settles.

Furthermore, a gas turbine engine can thus also have a simple construction because the engine accessories and the devices of a gas turbine engine which interact with the engine accessories can be positioned close to one another spatially.

Arranging the aircraft accessories radially outside the bypass channel provides the additional advantage that the gas turbine engine according to the present invention can be used in various aircraft designs in a simple manner and without having to make complex design changes for this purpose. This is because only accessories which are each provided to supply the functions of an aircraft are to be adapted to the various aircraft designs. This adaptation has no effect on the basic construction of the gas turbine engine itself which is provided for the operation of the gas turbine engine. Since a gas turbine engine according to the present disclosure can be combined with various aircraft at low cost, advantages in terms of cost can be achieved in a simple manner.

Furthermore, an inside diameter of the bypass channel can be increased by comparison with known gas turbine engines in order to be able to arrange substantially all the engine accessories required for the operation of a gas turbine engine radially inside the bypass channel. This measure reduces installation space requirements outside the bypass channel and thus installation space requirements radially inside an engine nacelle for the other accessories, since substantially only aircraft accessories are then to be arranged in this region.

So as not to limit the flow cross section of the bypass channel as a result of the increase in the inside diameter thereof, the outside diameter of the bypass channel can be increased. Since both the inside diameter and the outside diameter of the bypass channel are then greater, the height of the bypass channel is then smaller by comparison with a height of a bypass channel having a smaller inside diameter and a smaller outside diameter. The smaller height of the bypass channel in conjunction with the smaller installation space requirements outside the bypass channel makes it possible to make the total diameter of a gas turbine engine smaller, as a result of which the length of a gas turbine engine is also reduced in comparison with known solutions. This ultimately leads to a reduced level of flow drag of a gas turbine engine, which has a positive effect on fuel consumption.

The gas turbine engine according to the present disclosure can then be designed so as to be advantageous in terms of installation space when the electric machine is arranged in the circumferential direction at least in part in a region of the gas turbine engine in which the gas turbine engine comprises means which are designed to connect the gas turbine engine to an aircraft. In this case, it can be provided that the region of the gas turbine engine overlaps a fuselage of the aircraft when the engine is installed on the aircraft.

In the case of another embodiment of the gas turbine engine according to the present disclosure, the engine accessory gearbox is designed to transmit a torque and to drive an oil pump, a fuel pump, an air/oil separator and/or a permanent magnet alternator (PMA). The oil pump can be provided to supply oil, in particular to lubricate and cool regions and components of the gas turbine engine. In particular, the spatial proximity of the engine accessories which are provided for supplying fuel and oil to the gas turbine engine allows an optimized integrated solution.

An electrically operable hydraulic pump can be an aircraft accessory and can be arranged radially outside the bypass channel at any point in particular also in the fuselage of an aircraft. Furthermore, the hydraulic pump, which is provided to supply hydraulic systems of an aircraft, can be connected to the electric machine and can receive electrical energy from the electric machine. In turn, the gas turbine engine can then be designed to be advantageous in terms of installation space. This is because electrical lines having substantially higher degrees of freedom than mechanical couplings, such as shafts and the like, can be laid.

The higher degrees of freedom make it possible to arrange the electrically operable hydraulic pump in regions of the gas turbine engine, according to the present disclosure, outside the bypass channel, which regions have a corresponding installation space.

The engine accessory gearbox can be arranged between the engine core and the bypass channel in the axial direction in the region of a rear side of a front engine frame. Since the associated fuel and oil system, such as an oil tank, a fuel-cooled oil cooler, a fuel control unit and the like, is conventionally likewise installed in this region of a gas turbine engine, as a result of the spatial proximity which is then present, a simplified installation and a connection of the engine accessories to the engine accessory gearbox which is advantageous in terms of installation space are then possible.

Moreover, the engine accessory gearbox can be supplied with cooling and lubricating oil by means of an oil system of the gas turbine engine in so far as necessary.

The construction of the gas turbine engine according to the present disclosure can be designed in such a way that it can be arranged on both sides of an aircraft without having to provide substantial differences in design for this purpose. An installation option of this type or a property of this type of a gas turbine engine is also referred to as non-handed installation. To implement a possible non-handed installation, a corresponding arrangement of the engine accessory gearbox and the electric machine in the circumferential direction of the gas turbine engine can be provided. When the electric machine is arranged directly on the core shaft in the circumferential direction of the gas turbine engine, it is thus possible for example to arrange the engine accessory gearbox outside a region of overlap between the gas turbine engine and a fuselage of the aircraft. As a result, in particular maintenance for regions of the gas turbine engine close to the engine core can also be simplified.

According to another aspect, an aircraft comprising at least one gas turbine engine as described in greater detail above is provided. The gas turbine engine can be arranged on the fuselage or in the fuselage of the aircraft. The electric machine is arranged radially outside the bypass channel in a region of overlap between the gas turbine engine and the fuselage. The electric machine can thus be arranged outside the bypass channel in such a way that the gas turbine engine itself can be designed with the smallest possible external dimensions.

In this case, it can be provided that the electric machine is arranged radially in the engine nacelle, in part radially in the engine nacelle and in part radially outside the engine nacelle, for example in a pylon and/or the fuselage, or radially outside the engine nacelle in the pylon and/or in the fuselage.

Furthermore, it is also possible to arrange the electric machine in a region between the engine nacelle and the fuselage of an aircraft which is delimited by the engine nacelle, the fuselage and an aerodynamic casing. By means of an aerodynamic casing of this type, a transition between the engine nacelle and the fuselage of an aircraft which is optimized in terms of flow is provided.

In particular, arranging the electric machine radially outside the engine nacelle makes it possible to design the gas turbine engine according to the present disclosure with the smallest possible diameter and to reduce drag and a component weight of the gas turbine engine to a minimum.

If the electric machine is arranged so as to be radially aligned with the radial shaft of the drive train in the engine nacelle, in the pylon and/or in the fuselage, an outside diameter of the gas turbine engine in turn can be designed to be as small as possible.

In the case of another embodiment of the aircraft according to the present disclosure, in each case one gas turbine engine is provided at least on both sides of the fuselage.

It is self-evident to a person skilled in the art that a feature or parameter described in relation to one of the above aspects can be applied to any other aspect, unless they are mutually exclusive. Furthermore, any feature or any parameter described here may be applied to any aspect and/or combined with any other feature or parameter described, unless they are mutually exclusive. Further advantages and advantageous developments of the invention can be found in the claims and the exemplary embodiments described based on the concept with reference to the drawings,

in which:

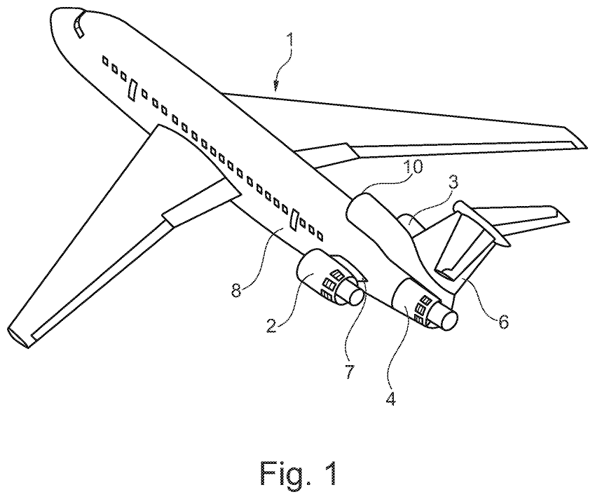

FIG. 1 is a simplified three-dimensional view of an aircraft with gas turbine engines arranged in the rear region on an aircraft fuselage;

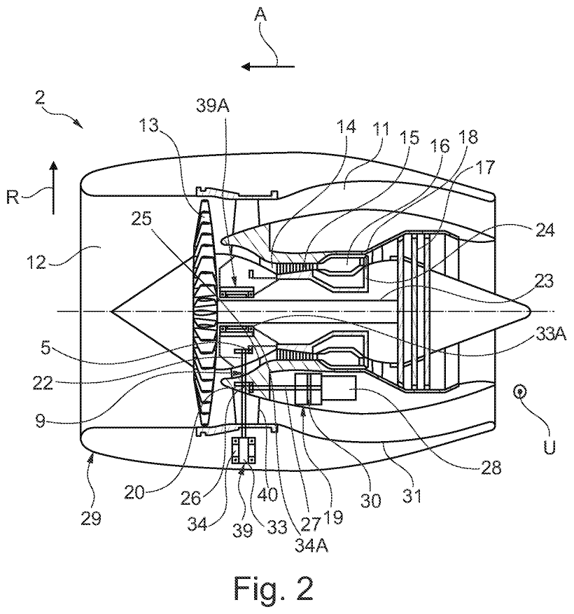

FIG. 2 is a simplified longitudinal sectional view of a gas turbine engine of the aircraft according to FIG. 1;

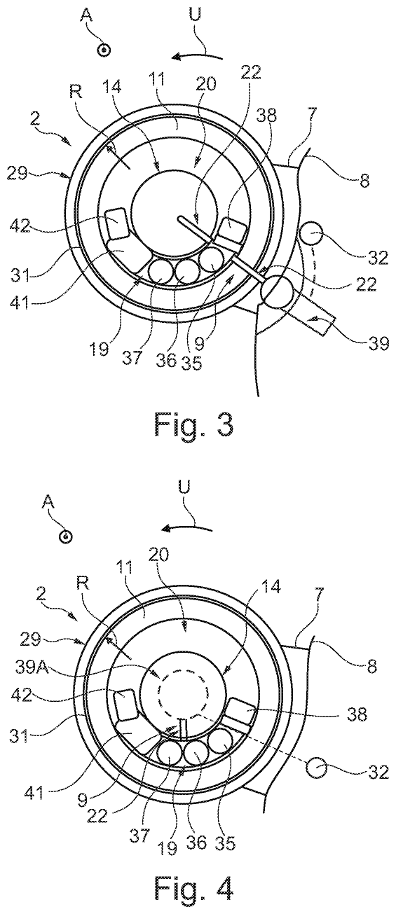

FIG. 3 is a simplified cross-sectional view of the gas turbine engine according to FIG. 2; and

FIG. 4 shows an illustration corresponding to that of FIG. 3 of another embodiment of the gas turbine engine according to FIG. 2.

FIG. 1 shows an aircraft or a passenger aircraft 1 which has three gas turbine engines 2, 3, 4. The first gas turbine engine 2 is arranged on a left-hand side of the aircraft in the rear region of the aircraft 1, in the region of a vertical stabilizer 6, and is attached in the region of an engine pylon 7 to a fuselage 8 of the aircraft 1. The second gas turbine engine 3 is connected to the fuselage 8 substantially mirror-symmetrically on a right-hand side of the aircraft.

The third gas turbine engine 4 is positioned at the rear end of the fuselage 8 and is attached to an inner fuselage strut, which is arranged below the vertical stabilizer 6 of the aircraft 1. An air inlet 10 is provided to supply air to the third gas turbine engine 4. The air inlet 10 is arranged, in front of the vertical stabilizer 6 in a direction of flight, on a top side of the fuselage 8 and is connected, within the aircraft fuselage 8, to the third gas turbine engine 4.

FIG. 2 is a simplified longitudinal sectional view of the gas turbine engine 2 of the aircraft 1 according to FIG. 1. The gas turbine engine 2 comprises a subsidiary flow channel or bypass channel 11 and an inlet region 12. Downstream of the inlet region 12, a blower 13 is connected in a manner which is known per se.

After the blower 13, the fluid flow in the gas turbine engine 2 is divided into a bypass flow and a core flow. The bypass flow flows through the bypass channel 11, whereas the core flow flows into an engine core 14. The engine core 14 is configured with a compressor device 15, with a burner 16, with a low-pressure turbine 17 which is provided to drive the blower 13, and with a high-pressure turbine 18 provided to drive the compressor device 15.

In addition, FIG. 2 is a schematic view of an engine accessory gearbox 19 which is arranged substantially in the region of an intermediate casing 20 of the gas turbine engine 2. The intermediate casing 20 is located in the radial direction R of the gas turbine engine 2 in a region between the engine core 14 and the bypass channel 11.

Furthermore, an electric machine 39 is provided radially outside the bypass channel 11. The electric machine 39 can be operated both as a motor and as an alternator so as to be able to start the gas turbine engine 2 and to generate electrical energy in the operation of the gas turbine engine 2. By means of the electrical energy of the electric machine 39, which is what is known as a starter alternator of the gas turbine engine, for example an electric hydraulic pump and an on-board network of the aircraft 1 can be operated.

The engine accessory gearbox 19 and the electric machine 39 are driven by a radial shaft 22 of a drive train 9 which is operatively connected to a core shaft 24 of the gas turbine engine 2, which core shaft extends in the axial direction A of the gas turbine engine 2. The radial shaft 22 is connected to the core shaft 24 by means of an angle drive 5. In the present case, the core shaft 24 is a high-pressure shaft of the gas turbine engine 2 which, in the operation of the gas turbine engine 2, rotates at a higher speed than another core shaft 23 arranged coaxially therewith which is what is known as a low-pressure shaft.

Starting from the core shaft 24, the radial shaft 22 extends substantially in the radial direction R of the gas turbine engine 2 through what is known as an inner strut 25, that is to say a strut formed with a hollow profile or an aerodynamic profile formed with a hollow profile, outwards through the engine core 14 to the intermediate casing 20. In the region of the intermediate casing 20, the radial shaft 22 interacts with a drive shaft 27 by means of another angle drive 26 in the form of a bevel gear set.

By means of gear pairs 30 of the engine accessory gearbox 19, which in the present case are in the form of spur-gear stages, the drive shaft 27 is connected to what are known as engine accessories 28. In the present case, the engine accessories 28 are an air/oil separator, an oil pump, a fuel pump, a permanent-magnet alternator and other accessories which are provided for the operation of the gas turbine engine 2. The oil pump supplies the gas turbine engine 2 with oil for lubrication and cooling. In addition, in the intermediate casing 20, an oil tank and an oil cooler which can be temperature-controlled by fuel are also arranged radially inside the bypass channel 11 in the gas turbine engine 2.

The electric machine 39 is arranged radially in an engine nacelle 29 which is delimited radially outwardly by an outer side of the engine nacelle 29 and radially inwardly by an outer side 31 of the bypass channel 11. Starting from the intermediate casing 20, the radial shaft 22 extends inside an outer strut 40 radially through the bypass channel 11 as far as the electric machine 39. The electric machine 39 is arranged coaxially with the radial shaft 22 and so as to be radially aligned therewith. This means that a rotor 33 of the electric machine 39 which is connected to the radial shaft 22 for conjoint rotation rotates about the longitudinal axis of the radial shaft 22. Furthermore, the rotor 33 is rotatably mounted on a stator 34 of the electric machine 39.

FIG. 2 also shows another electric machine 39A which is arranged radially inside the engine core 14 and has the same range of functions as the electric machine 39. In this case, it is provided that the gas turbine engine 2 is configured either with the electric machine 39 radially outside the bypass channel 11 or with the electric machine 39A radially inside the engine core 14. In the case of the embodiment of the gas turbine engine 2 in which the electric machine 39A is arranged radially inside the engine core 14, the radial shaft 22 extends in the radial direction R only between the angle drive 5 and the other angle drive 26. That is to say that the radial shaft 22 is then not guided radially outwards through the bypass channel 11.

The electric machine 39A is arranged coaxially with the core shaft 24. In this case, the rotor 33A of the electric machine 39A is connected to the core shaft 24 for conjoint rotation so as to be able to introduce a corresponding torque into the core shaft 24 in the motor operation of the electric machine 39A when starting the gas turbine engine 2. At the same time, in the alternator operation of the electric machine 39A, the rotor 33A can be driven by the core shaft 24 by means of the connection to the core shaft 24 for conjoint rotation in order to generate electrical energy. The rotor 33A is arranged radially inside the stator 34A and rotatably mounted thereon.

According to the present application in each case, it can also be provided that the engine accessory gearbox 19 is operatively connected to the other core shaft 23. Irrespective thereof, the electric machine 39A is operatively connected to the core shaft 24 in order to allow the gas turbine engine 2 to be started by the electric machine 39A.

FIG. 3 is a simplified cross-sectional view of the embodiment of the gas turbine engine 2 according to FIG. 2, in which the electric machine 39 is arranged radially outside the bypass channel 11 and even radially outside the engine nacelle 29 in the engine pylon 7. In the present case, an electrically drivable hydraulic pump 32 is what is known as an aircraft accessory.

In the exemplary embodiment of the gas turbine engine 2 shown in FIG. 3, the engine accessory gearbox 19 is arranged together with the engine accessories radially between the bypass channel 11 and the engine core 14. In the present case, the engine accessories are inter alia the previously mentioned fuel pump 35, the air/oil separator or a breather 36 and the oil pump 37. Furthermore, a fuel metering unit 38 (FMU), a measuring nozzle for controlling the amount of fuel which arrives at the burner 16, a fuel filter and an oil filter, an oil tank 41 and an oil cooler 42 which can be temperature controlled by means of fuel are also provided on the engine core 14 so as to be distributed in the circumferential direction U.

FIG. 4 shows the embodiment of the gas turbine engine 2 in which the electric machine 39A is arranged radially inside the engine core 14 and is directly connected to the core shaft 24.

### LIST OF REFERENCE SIGNS

1 Aircraft
2 to 4 Gas turbine engine
5 Angle drive
6 Vertical stabilizer
7 Engine pylon
8 Fuselage
9 Drive train
10 Air inlet
11 Bypass channel
12 Inlet region
13 Blower
14 Engine core
15 Compressor device
16 Burner
17 Low-pressure turbine
18 High-pressure turbine
19 Engine accessory gearbox
20 Intermediate casing
22 Radial shaft
23 Core shaft, low-pressure shaft
24 Core shaft, high-pressure shaft
25 Inner strut
26 Additional angle drive
27 Drive shaft
28 Engine accessory
29 Engine nacelle
30 Gear pair
31 Outer side of the bypass channel
32 Hydraulic pump
33, 33A Rotor
34, 34A Stator
35 Fuel pump
36 Air/oil separator
37 Oil pump
38 Fuel metering unit
39, 39A Electric machine
40 Outer strut
41 Oil tank
42 Oil cooler
A Axial direction
R Radial direction of the gas turbine engine
U Circumferential direction

1. A gas turbine engine, comprising an engine core and comprising a bypass channel which radially surrounds the engine core at least in part, wherein a core shaft extending in the axial direction is operatively connected to an engine accessory gearbox which is arranged between the engine core and the bypass channel by means of a radial shaft of a drive train, wherein an electric machine is provided which is designed to start the gas turbine engine during motor operation and to generate electrical energy during alternator operation, wherein the electric machine is arranged coaxially with the core shaft and is connected thereto for conjoint rotation or is arranged radially outside the bypass channel and is operatively connected to the core shaft by means of the radial shaft, and wherein a rotor of the electric machine is arranged coaxially with the radial shaft and is connected thereto for conjoint rotation.

2. The gas turbine engine according to claim 1, wherein the rotor is rotatably mounted in a stator of the electric machine.

3. The gas turbine engine according to claim 1, wherein engine accessories are substantially operatively connected to the drive train by means of the engine accessory gearbox, which engine accessories are provided to carry out functions of the gas turbine engine and are arranged between the engine core and the bypass channel.

4. The gas turbine engine according to claim 1, wherein the electric machine is designed to substantially supply electrical energy to aircraft accessories which are provided to carry out functions of an aircraft which is configured with the gas turbine engine.

5. The gas turbine engine according to claim 4, wherein the aircraft accessories are arranged radially outside the bypass channel.

6. The gas turbine engine according to claim 1, wherein the electric machine is arranged in the circumferential direction at least in part in a region of the gas turbine engine in which the gas turbine engine comprises means which are designed to connect the gas turbine engine to an aircraft, the region of the gas turbine engine overlapping a fuselage of the aircraft when the engine is installed on the aircraft.

7. The gas turbine engine according to claim 1, wherein the engine accessory gearbox is designed to transmit a torque and to drive an oil pump, a fuel pump, an air/oil separator and/or a permanent magnet alternator.

8. The gas turbine engine according to claim 4, wherein an electrically operable hydraulic pump is an aircraft accessory, is arranged radially outside the bypass channel, is operatively connected to the electric machine and can receive electrical energy therefrom.

9. The gas turbine engine according to claim 1, wherein the engine accessory gearbox is arranged in the axial direction in the region of a rear side of a front engine frame between the engine core and the bypass channel.

10. An aircraft, comprising at least one gas turbine engine according to claim 1, wherein the gas turbine engine is arranged on the fuselage or in the fuselage of the aircraft, and wherein the electric machine is arranged in a region of overlap between the gas turbine engine and the fuselage radially outside the bypass channel.

11. The aircraft according to claim 10, wherein the electric machine is arranged radially in an engine nacelle, in part radially in the engine nacelle and in part radially outside the engine nacelle in an engine pylon and/or the fuselage or radially outside the engine nacelle in the engine pylon and/or in the fuselage.

12. The aircraft according to claim 10, wherein the electric machine is arranged so as to be radially aligned with the radial shaft in the engine nacelle, in the engine pylon and/or in the fuselage.
